(19) United States
(12) Patent Application Publication
(10) Pub. No.: US 2005/0041036 A1
(43) Pub. Date: Feb. 24, 2005

(54) Blending multiple images for high resolution display

(75) Inventors: Chandrasekhar Narayanaswami, Wilton, CT (US); Mandayam Thondanur Raghunath, Fishkill, NY (US); John Peter Karidis, Ossining, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation, Armonk, NY (US)

(21) Appl. No.: 10/643,034

(22) Filed: Aug. 18, 2003

(51) Int. Cl. G09G 5/02

(52) U.S. Cl. 345/605

(57) ABSTRACT

A system and method for transforming multiple one-bit per pixel images for presentation on a device comprises the steps of: converting the one-bit per pixel images to multiple bits per pixel images; overlapping the images according to an overlap function; converting the overlapped image into a dithered one-bit per pixel image by applying a spatial dithering algorithm; and presenting the dithered image on a display. Another method according to the invention comprises the steps of: applying different stipple patterns to one-bit per pixel images; then overlaying the stippled images to create a composite stippled image; and presenting the stippled image on a display. An apparatus configured for carrying out the above steps for displaying multiple images on a high resolution display comprises: a processor, random access memory, erasable programmable memory, and an input/output subsystem, including a display.

### CROSS-REFERENCE TO RELATED APPLICATIONS

Not applicable.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of electronic displays for electronic devices and more particularly relates to the field of high-resolution displays for small, hand-held devices.

### BACKGROUND OF THE INVENTION

Wristwatches are small, lightweight, and can communicate information to a user at a glance, making them the most widely-used accessory. Wristwatches not only display the time and date, they can also function as stopwatches, alarms, and calendars. Microchips have enabled computing power in very small devices and wristwatches are a popular choice for encasing this computing power. Some of the recent developments in wristwatch technology are detailed in U.S. Pat. No. 6,525,997 B1 “EFFICIENT USE OF DISPLAY REAL-ESTATE IN A WRIST WATCH DISPLAY” and “Application Design for a Smart Watch with a High Resolution Display” by Chandra Narayanaswami and M. T. Raghunath, both of which are incorporated by reference as if fully set forth herein. Although these “smart watches” can be configured to receive, store and display large amounts of data, the small size of the average watch face, approximately 22 mm×17 mm, makes discerning any significant amount of display data very difficult.

One of the solutions to the problem of displaying a large amount of data on a small screen is to partition the data into multiple images and then display the multiple images simultaneously, by overlaying them. For this method to work, each image must appear distinct from the other overlapped images so that the human eye can readily distinguish the data contained in each image. With color displays the images are made to appear distinct by displaying the images in layers, where each layer is formatted in a different color. For example, the first layer might be red, the second blue and the third yellow. The human eye will be able to distinguish among the different colored images. For gray scale displays, the images are also layered, each image in a different gray level (shade of gray). If the gray scale shades are sufficiently different and distinct, the human eye will be able to distinguish among the images relatively easily. This is because gray scale and color displays have a greater pixel depth (number of bits per pixel), typically using from 4 to 24 bits per pixel, providing a wide range of colors and gray levels. Thus this overlaying method is used quite successfully with color and gray scale display monitors and works particularly well with text displays. Highly-detailed graphical images are more difficult to distinguish when overlaid.

With gray scale displays, other methods can also be used to make multiple overlaid images appear distinct. Referring to FIG. 1 there is shown an enlarged view of a display where a text image is shown in full brightness against a dimmed graphical image which appears to recede into the background. This is a known technique of displaying two images simultaneously. This method is used to its fullest effect when one image is a text image and the other one is a graphic. This effect can be produced by overlaying the two images using known overlap functions, such as the AVERAGE, ADD, MAX, and TOP methods, discussed briefly below. While these functions work well with gray scale displays, they tend to produce poor quality images when used on purely monochrome (one bit per pixel) displays.

With gray scale displays, the overlap works this way. In gray scale each pixel value is an integer. The size of the integer depends on the number of bits per pixel. For a 4-bit image the pixel values range from 0 through 15 (0 being white and 15 being black). Table 1 shows the results of an ADD operation performed on two images composed of 4-bit pixels. The ADD overlap function adds the corresponding pixel values.

A gray level of 25% is assigned to Image A and a gray level of 75% is assigned to Image B. Assuming a 4-bit pixel, the maximum integer value for Image A is 3 and the maximum integer value for Image B is 12 (25% and 75% of 15, respectively), for a total combined value of 15. Referring to Table 1 the ADD overlap function with a 25/75 gray scale results in four possible values for each pixel: 0, 3, 12 and 15. If more than two images are used, the number of possible combinations will increase.

TABLE 1

| | ADD Operation | | |
|---|---|---|---|
| | Image A (25%) | Image B (75%) | Resultant Image |
| Pixel 1 | 0 | 0 | 0 |
| Pixel 2 | 0 | 1 | 12 |
| Pixel 3 | 1 | 0 | 3 |
| Pixel 4 | 1 | 1 | 15 |

The AVERAGE function as applied to gray scale images simply adds the respective gray level values and divides that sum by the number of images being overlaid. Table 2 shows how the AVERAGE function works with the images of Table 1.

TABLE 2

| | AVERAGE Operation | | |
|---|---|---|---|
| | Image A (25%) | Image B (75%) | Resultant Image |
| Pixel 1 | 0 | 0 | 0 |
| Pixel 2 | 0 | 1 | 6 |
| Pixel 3 | 1 | 0 | 2 |
| Pixel 4 | 1 | 1 | 7 |

The MAX function takes the maximum value for the pixel from the corresponding pixel values of all images. In other words, the darkest pixel among the overlaid images is used. Using this method will result in the darkest image appearing to be on top of the other images. Table 3 shows results from the MAX operation applied to the images of Table 2.

TABLE 3

| | MAX Operation | | |
|---|---|---|---|
| | Image A (25%) | Image B (75%) | Resultant Image |
| Pixel 1 | 0 | 0 | 0 |
| Pixel 2 | 0 | 1 | 12 |
| Pixel 3 | 1 | 0 | 3 |
| Pixel 4 | 1 | 1 | 12 |

The ADD, AVERAGE, and MAX methods work well when overlaying gray scale images, provided there is little or no overlap of black pixels. As stated earlier, for monochrome displays, the results can be poor. The reason for this is that with a strictly monochrome image only one bit is used per pixel. Each pixel represents a dot of color, usually black or white, but other combinations, such as green and black, are possible. Assuming a black and white monochrome display, each pixel represents either a black or a white dot. If the pixel is ON, then the pixel, or dot, appears black. If the pixel is OFF, the pixel appears white.

Because color and gray-scale displays (with multiple bits per pixel) in wristwatches are much more expensive than monochrome (one bit per pixel) displays and consume so much more power, current wristwatch technology favors the use of monochrome displays. Therefore there is a need for comparable methods of simultaneous display of multiple images for strictly monochrome displays such as those found in wristwatches.

Referring to FIG. 2 there is shown an illustration of the “TOP” method for displaying multiple images simultaneously. The TOP method is employed to its best advantage when one image is significantly smaller than the other. Referring to FIG. 2 we see that a “text box” image 210 is much smaller than a circle image 220. Assume that these two images are both one-bit images. The larger image, the circle 220, is 320×240 pixels and the top image, the text box 210, is 100×100 pixels. The text box 210 can be overlaid over the circle 220 to create a combined image 230. As can be seen the 100×100 overlapped region simply shows the top image. This is similar to what happens when a pop-up window appears on a computer screen. This particular method is limited to images where one image is significantly smaller than another image and where the larger image can remain discernible even if part of it is obstructed by the smaller image.

FIG. 3 shows a simplistic example of the XOR operation applied on two monochrome black/white images. The black square 310 contains all pixels set to 1 (black). The text image 320 contains a combination of 1 and 0 pixels (black and white). Performing the XOR operation on these two images produces the combined image 330. As is clearly shown, any overlapping pixels of image 330 which are both black are reversed to white. Overlapping pixels which are both white and black are shown as black, limiting the use of this overlap method on monochrome displays to very basic images.

Other methods for displaying large amounts of data (text and/or graphics) on a small display screen include rotating and scrolling multiple images on the display. The drawback with these methods is that only one screen is visible at a time. There are situations where a user requires the simultaneous display of more than one image. Referring back to the image of FIG. 1 there is shown an example of various items of information which a user might need to reference concurrently. The image of FIG. 1 displays information about a business meeting and it also displays the current time on a handheld device such as a wristwatch. This data can be received by the wristwatch using a wireless short-range transmission standard such as Bluetooth. Optionally, the data can be transmitted from a personal computer, personal device assistant, or other apparatus through a cable.

If using the scrolling/rotating feature, then the meeting details shown in FIG. 1 are viewable, but not the current time, and vice versa. This presents a problem, perhaps if the user needs to time a call-in to the meeting conference to sync with another party's call. Rotating or scrolling through the screens to view all of the required information is too cumbersome.

Spatial dithering algorithms are used in the known art to simulate shades of gray in black and white images. Dithering can be described as the process of juxtaposing pixels of two different colors to create the illusion of a third color that has an intermediate color between the colors of the original palette. Dithering is also used to reduce color intensity. A common example of one application of this algorithm is where a graphical image is overlaid with text. The text appears in full brightness while the graphical image appears less intensely. An image generated using this spatial dithering algorithm when viewed on a monochrome display is perceived as a dim graphical image with bright text over it even though the underlying displays have no support for gray scale.

In a high resolution monochrome black and white display, dithering simulates shades of gray by creating complex black and white patterns within black dots in a cell. This produces different pixel intensities over a colored space rather than a single intensity. Dithering is similar to “halftoning” which is used in newspaper photographs and computer printers. In halftoning the dots are placed in a regular grid format at fixed predetermined intervals and the size of the dots is an analog value that changes with the desired gray level. Larger dots are used for darker shades, smaller ones for lighter shades.

Dithering can be considered the digital equivalent of halftoning. In dithering each dot is of a fixed size and can only be black or white. So gray scale is simulated by making sure that on average in a region the desired number of dots is black. In a region that needs to be seen as gray, the ratio of the number of black pixels to white pixels is adjusted so that the average number of black pixels corresponds to the gray level. The more black dots printed in a cell, the darker the gray shade. The gray scale regions within the image are converted to a black and white pattern by distributing the black dots according to how dark the spatial region is. This creates the illusion of shades of gray. This visual perception is heightened when the display has a high resolution. High resolution displays have pixels which are closer together and when pixels are closer together the spatial placement of black and white dots is more likely to be seen by the eye as gray since the eye cannot see the individual pixels. For example, viewing the “gray” area of a newspaper image through a magnifying glass reveals that the “gray” area is actually a multitude of black dots.

Exactly which pixels are black and which ones are white is decided by a dithering algorithm. The dithering algorithm selects patterns for the black and white dots. It is preferable to select complex patterns and avoid simple patterns such as making every fourth pixel black because such simple patterns will result in stripes that the human eye will readily distinguish. If the pattern is too obvious and does not blend well, the eye will not process the image as a gray image. Differing patterns of black and white are used for each shade of gray so that the human eye can distinguish among the images. We discuss black and white patterns in this example, but it is to be understood that other monochrome combinations, such as green and black, could be used as well. Since dithering requires computation, it may not always be practical to implement on small devices with limited computational power.

FIG. 4 shows an example of a dithered image. The circle 410 is dithered with one pattern of black and white dots and the rectangle 420 is created with a different pattern. The dithering pattern used in the rectangle 420 has a sparser placement of black dots than the circle 410 pattern, therefore the rectangle appears lighter. Overlaying the two images creates the perception of a third color where the two shapes intersect.

Another known method for converting images is stippling. Stippling is used generally to create patterns within objects so that two objects with different stipple patterns can be differentiated when they are overlaid. Stippling results are generally not as good (visually appealing) as images resulting from dithering applied to gray scale. However, stippling is much faster from a computational perspective. This is because dithering requires viewing the image as a whole and converting gray regions to appropriate ratios of black to white dots. With dithering, it is important that the placement of the dots be somewhat randomized so that ugly patterns do not show up in the resultant image. This drives up the expense in terms of computation time. On the other hand, the drawback to stippling is that it does not generally produce as high quality an image as dithering. However, the perceived image quality depends on the actual stipple pattern that is chosen. The simpler the pattern the faster the operation, but the resultant image will not be as clear. The more elaborate the pattern, the better the illusion.

Referring to FIG. 5 there are shown examples of two stipple patterns. Image 510 shows a common “checkerboard” pattern. Image 520 shows a second stipple pattern. Other commonly-used stipple patterns are vertical, horizontal, and diagonal stripes. Stippling involves taking a pattern, such as the checkerboard pattern 510 and ANDing it with an image that is supposed to be at a 50 percent gray scale (because a chess board has 50 percent white and 50 percent black squares). Next this image is ORed with a full strength (black) image. In this case the final image will show the ugly checkerboard pattern in the portion that was supposed to be gray. Obviously this is not as visually appealing as dithering, but this may be an acceptable trade-off of poorer image quality versus computation time. Another drawback to stippling is that it may not work for multiple overlapped images. Stippling works best when only two images are involved, one that is full strength and one that is dimmer.

Therefore, for these and other reasons there is a need for a product which overcomes the shortcomings of the prior art and facilitates an improved display of multiple images on hand-held monochrome displays.

### SUMMARY OF THE INVENTION

Briefly, according to an aspect of the invention, a method for transforming multiple one-bit per pixel (monochrome) images for presentation on a device comprises the steps of: converting the one-bit per pixel images to multiple bits per pixel images; overlapping the multiple bits per pixel images using an overlap function; converting the overlapped images into a dithered monochrome images by applying a spatial dithering algorithm; and presenting the dithered image on a display.

According to another aspect of the invention, a method for transforming multiple monochrome images for presentation comprises the steps of: applying differing stipple patterns to each of the monochrome images; overlaying the stippled images; and presenting the overlaid stippled image on a display.

An apparatus configured for carrying out the above steps for transforming images on a high resolution display comprises: a processor, random access memory, erasable programmable memory, and an input/output subsystem.

### BRIEF DESCRIPTION OF THE DRAWINGS

FIG. 1 is an enlarged view of a wrist watch display showing a text image overlaid on a graphic, according to the prior art.

FIG. 2 is an example of the TOP method for displaying overlaid images, according to the prior art.

FIG. 3 is an example of the XOR method for displaying overlaid images, according to the prior art.

FIG. 4 shows examples of the spatial dithering method, according to the prior art.

FIG. 5 shows examples of stipple patterns, according to the prior art.

FIG. 6 is a flow diagram illustrating a dithering method according to the invention.

FIG. 7 is an illustration of a dithered overlaid image, according to the invention.

FIG. 8 is a flow diagram illustrating a stippling method according to the invention.

FIGS. 9A, 9B and 9C illustrate the use of stippling, according to the invention.

FIG. 10 is a simplified diagram of a machine configured to operate according to an embodiment of the invention.

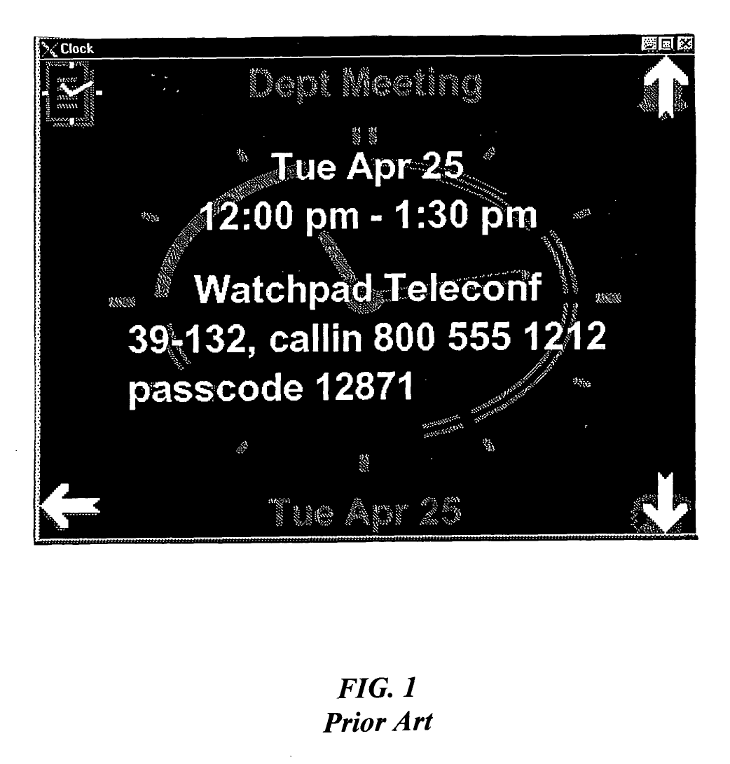

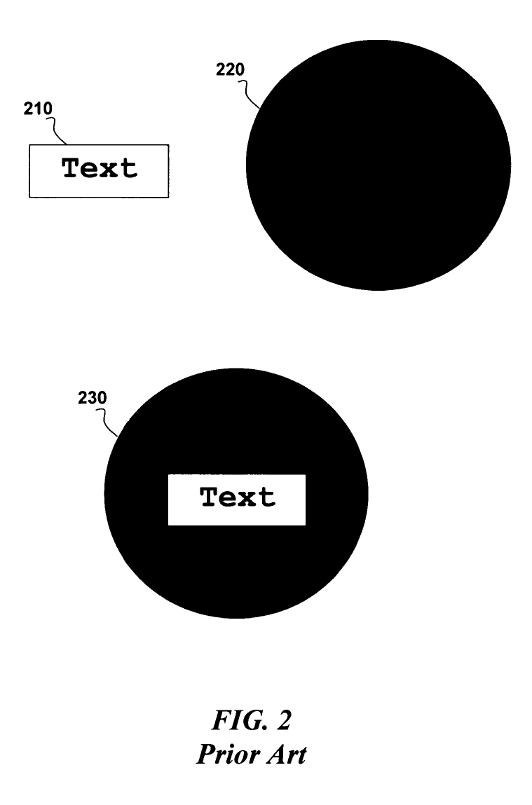

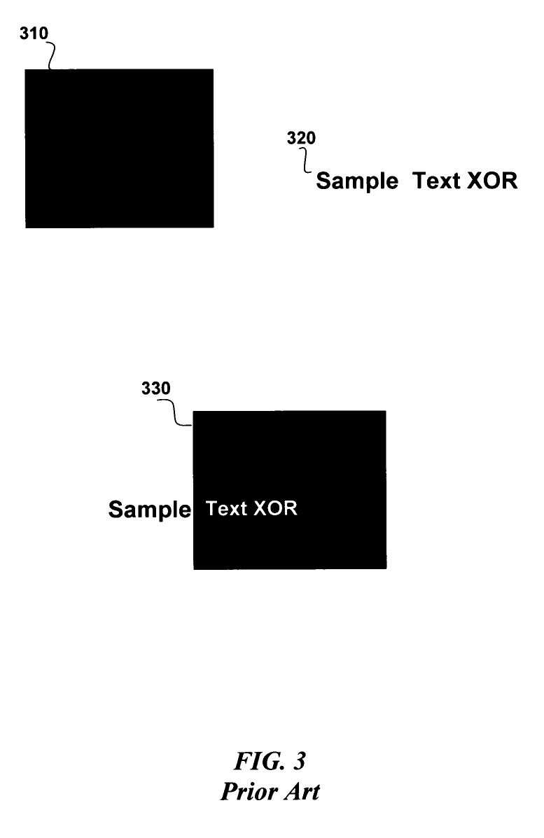

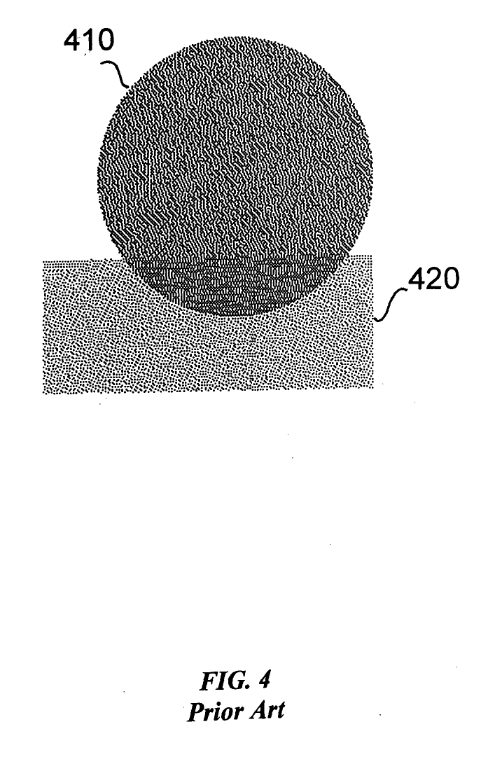

### DESCRIPTION OF THE PREFERRED EMBODIMENTS

We discuss methods and systems for transforming images for display on hand-held devices so that the images can be differentiated and easily read by a user. These methods, known as dithering and stippling, are well-suited for displaying a large amount of information on very small displays, such as wristwatch displays. In an embodiment of the invention, multiple images containing significant amounts of data can be simultaneously displayed on an area as small as 22 mm×17 mm, the dimensions of an average watch face.

While the dithering and stippling methods can be performed on color, gray scale, and monochromatic displays, because of the high cost and power consumption associated with color and gray scale displays on wristwatches, we discuss the application of these methods on a strictly monochrome display with a very high pixel density, as measured in dots per inch (dpi). A VGA (Video Graphics Array) resolution of at least 640×480 pixels, widely used in personal computer (PC) display monitors, is the preferred display resolution. The use of a spatial dithering algorithm, combined with a VGA resolution, enables multiple images to be simultaneously displayed in a visually appealing manner, according to the invention. In general, the stippling method will not produce as high quality an image, but it is much faster and more efficient from a computational perspective.

High resolution is generally associated with number of pixels per inch. The number of gray levels per pixel is determined by the number of bits per pixel (also known as pixel depth). Common pixel depths are 4 bits (with 16 gray levels), 8 bits (256 gray levels) or 24 bits (typically used in color displays with 8 bits for each of Red, Green and Blue). We discuss the application of the dithering and stippling methods on high resolution displays of low pixel depth.

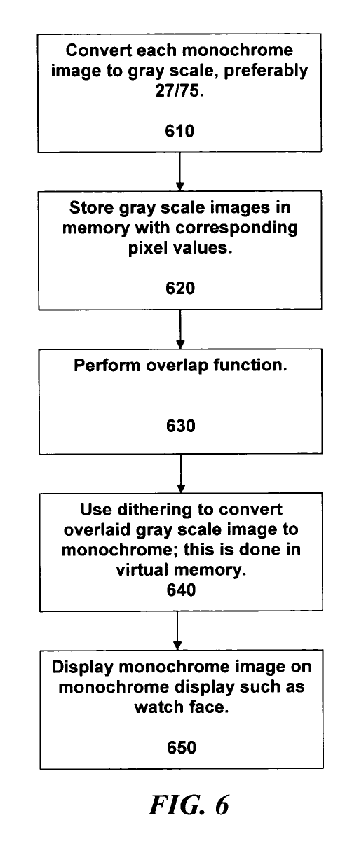

Referring to FIG. 6 we discuss a method, according to the invention, used to achieve a high resolution image wherein two separate and distinct monochrome images are displayed simultaneously on the display area of a small portable device, such as a wristwatch with a strictly black and white monochrome display. Assume the images are 1-bit monochrome images. The first step 610 is to convert the two monochrome images to gray scale. Due to the fact that the device is equipped with only a monochrome display, this conversion is done using virtual images which exist only in memory. Two different gray levels are used (preferably 25% and 75%) so that the images can be easily distinguished when overlaid. It would not be beneficial to use gray levels which are close on the gray level continuum from 0 to 100. For example, using 45% and 55% gray levels would not produce as clear an image.

When the images are in gray scale each pixel value is an integer. The size of the integer depends on the number of bits per pixel. For a 4-bit image the pixel values range from 0 through 15 (0 being white and 15 being black). If a 25% gray level is assigned to one image, then the maximum pixel value for that image is 3 (25% of 15). For a 75% gray level image, the maximum pixel value is 12. Assigning a gray level to an image could be done randomly, or it could be done so that one image is chosen to appear brighter and with more prominence. When two images with 25% and 75% gray levels are overlaid the outcome will appear as though the 75% gray level image is on top of the other image.

In step 620 the separate gray scale images are stored in memory with their corresponding pixel values. Next, in step 630 an overlap function is performed on the stored images. The overlap function can be one of any of the known overlap functions, such as AVERAGE, ADD, or MAX. When two gray scale images are overlaid, for each pixel we need to convert the corresponding two integers into a single integer. The overlap function is the function that specifies this mapping between the corresponding pixel values of the original images to the pixel value of the resultant image. Assuming the ADD operation is chosen as the overlap function in this example, then the corresponding pixel values are added. Therefore, if one image was set at 75% gray and the other one was set at 25% gray, the black pixels in the original images will appear as gray values of 12 and 3, respectively (for a 4-bit pixel image). In the regions where the originally black pixels overlap we get a gray value of 15 (i.e., fully black); in regions where only one of the original images was black, we get either 3 or 12 depending on which image had the black pixel. In regions where both original images had white, we get zero, i.e., white in the resultant image. If, as a result of the ADD operation, the pixel value becomes too large for the number of bits available, that portion of the image will appear as solid black.

In step 640 the overlaid gray scale image is converted to a composite monochrome image by applying a spatial dithering algorithm, again in memory. Spatial dithering algorithms are known to those with skill in the art. To perform the dithering algorithm the image is processed as a whole.

To explain how the image is processed, assume a simplistic one-dimensional dithering algorithm. To start, a counter value is maintained. The counter starts at zero. The pixel values in the gray scale image are scanned from left to right and top to down in a raster scan fashion. According to the algorithm, when the counter is >=50 we set the pixel to 1 (black) and subtract 100 from the counter. If the counter is <50 the pixel is set to 0 (white). If the fist pixel has intensity 70% the first pixel is set to black in the corresponding monochrome image and the counter is then set to −30 since the first pixel has 30% excess black (100% black minus 70% black). Then the next pixel in the image is scanned. Assume that this pixel is 50% black. Adding this value to the counter increases the counter to 20 and since 20 is less than 50 this pixel is set to white. With the counter now at 20 the next pixel is scanned and so on. One dimensional dithering can yield ugly snake-like patterns when transforming a solid gray area, especially when the gray level is not an even value like 50%, 25%, etc. Two dimensional dithering does a better job of distributing the black dots. With two dimensional dithering there are some additional computations that are employed to avoid ugly dot patterns in transforming a large region of the same gray level.

The last step, 650 is to display the converted monochrome image on the display.

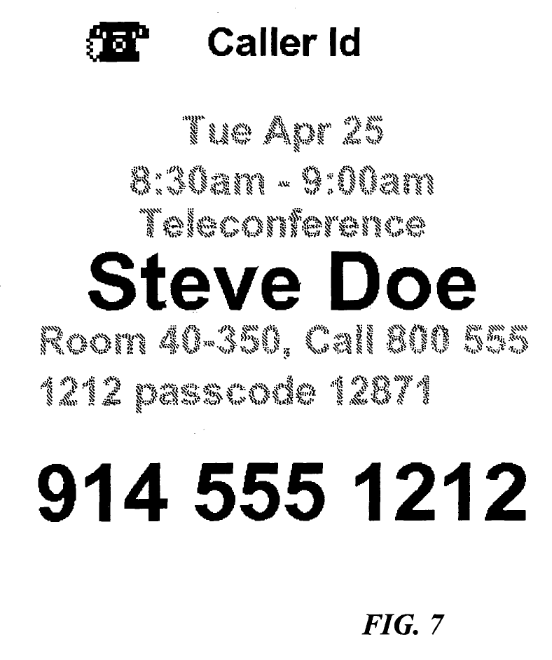

Referring to FIG. 7 there is shown an illustration of two images displayed simultaneously using the algorithm detailed in FIG. 6. In this example, a 25/75 gray scale conversion was used. It can be clearly seen from this image that the caller id information was allotted the 75% gray level, therefore it appears more prominently than the teleconference information. In this example, we assume that the caller id information was received after the teleconference information and the device will programmatically display the later, more recent information more prominently.

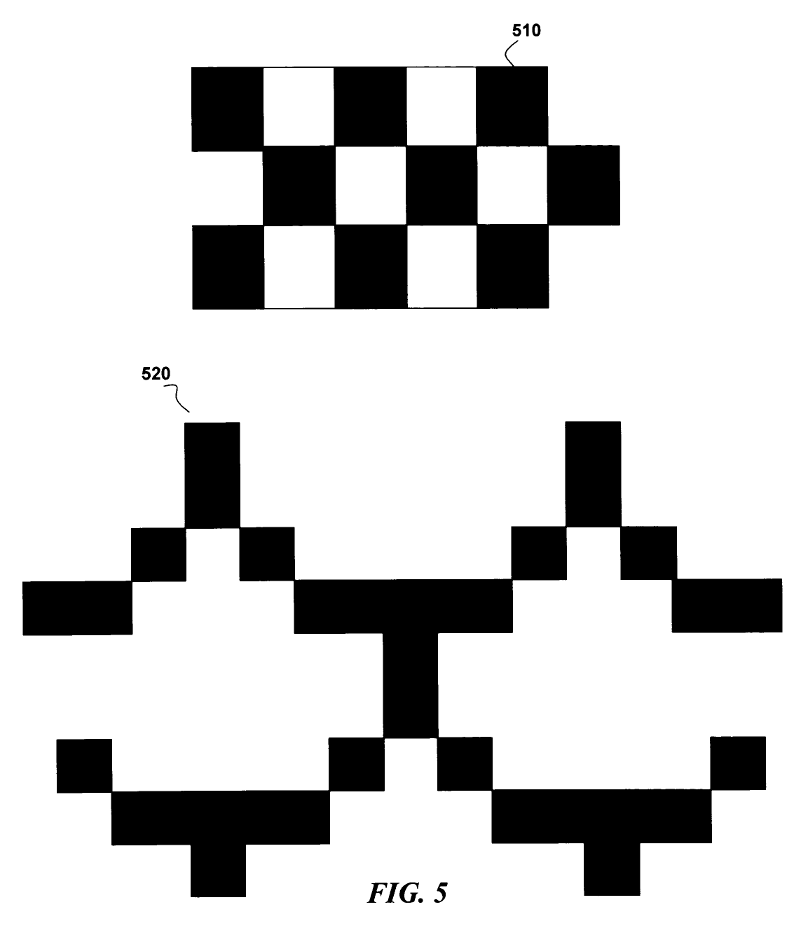

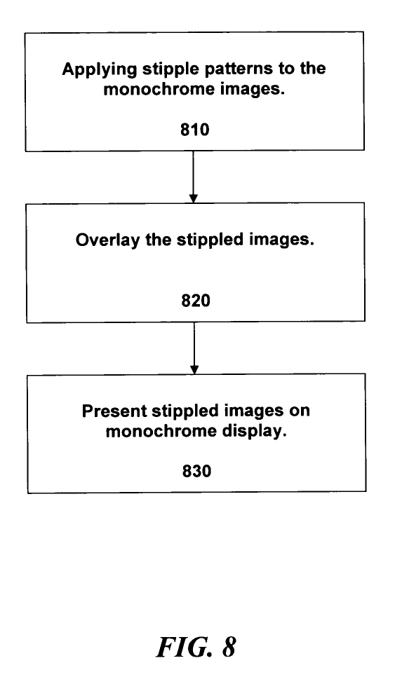

Another embodiment according to the invention involves the use of stippling. Referring to FIG. 8, the stippling embodiment proceeds as follows. First in step 810 two one-bit per pixel (monochrome) images are stippled, each one with a different stipple pattern. Assume that the stipple patterns of FIG. 5 are used. The stipple patterns are applied to the virtual images in memory. Next in step 820 the stippled images are overlaid, creating a composite stippled image. The final step 830 is the presentation of the composite stippled image on a monochrome display, such as a monochrome computer monitor or a display on a hand-held device.

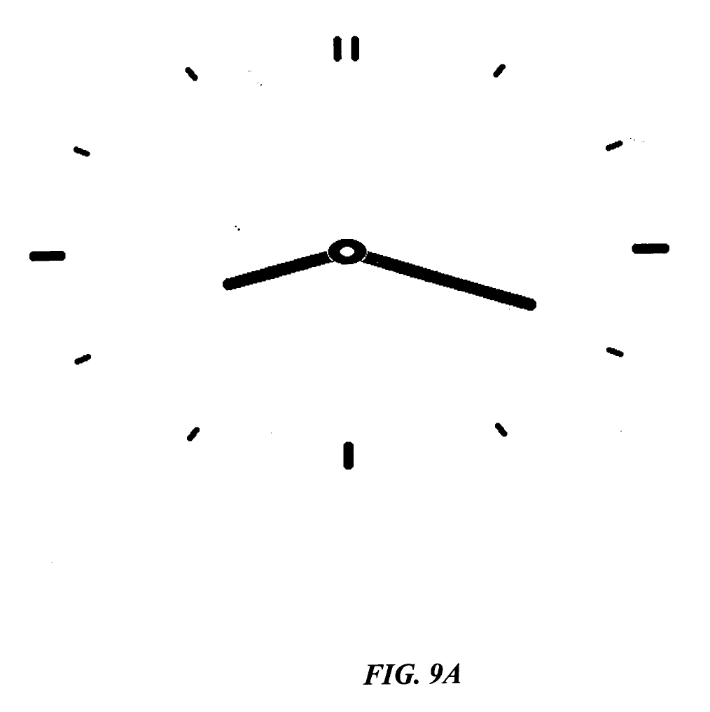

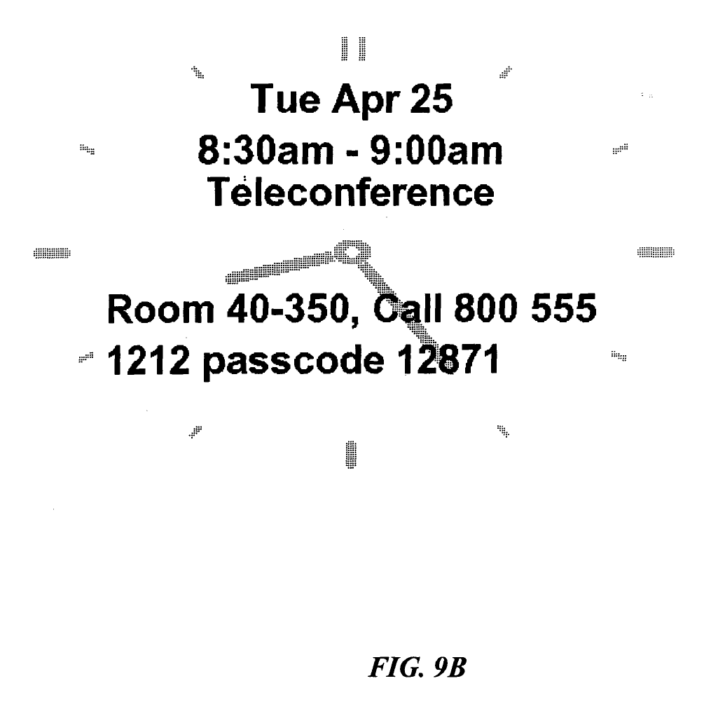

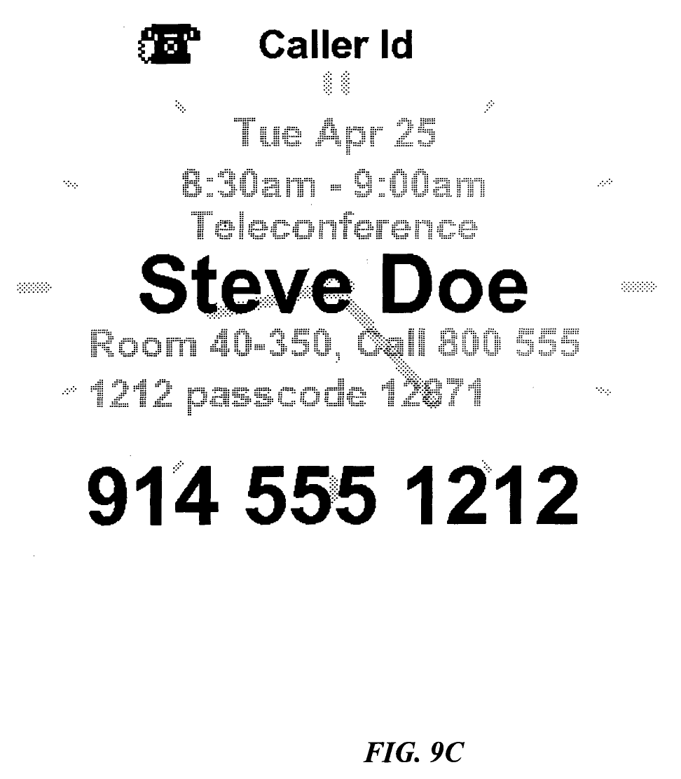

Referring to FIGS. 9A, 9B and 9C there are shown examples of the stippling method used according to an embodiment of the invention. Assume these images are displayed on a watch face and that they are all 640×480 pixels. First, image 9A shows the time as 8:19 A.M. At 8:25 A.M., according to a preset reminder, the upcoming meeting information is displayed as image 9B. In order to display both the current time and the meeting information and to reflect the higher precedence of the meeting information, the clock face (image 9A) is dimmed by applying stipple pattern 1 (the checkerboard pattern of FIG. 5) and the meeting info is displayed in black. Shortly thereafter the wearer gets a phone call on his cell phone. The caller ID from the wearer's cell phone transmits the information (according to known wireless technology) to the wearer's watch. The identity of the caller is displayed on the watch face in black as FIG. 9B. In image 9C it can be seen that the watch face has been dimmed even further (to reflect that it has receded in priority) by applying a sparser stipple pattern 2 (as shown in FIG. 5). The meeting info is also now dimmed using stipple pattern 1, and the caller ID information is displayed as black. These same images can also be processed using dithering. The dithering results will appear very similar to the stippling results. Another method which can be used is to apply a stipple pattern to a graphical image and then place text on top without a stipple pattern.

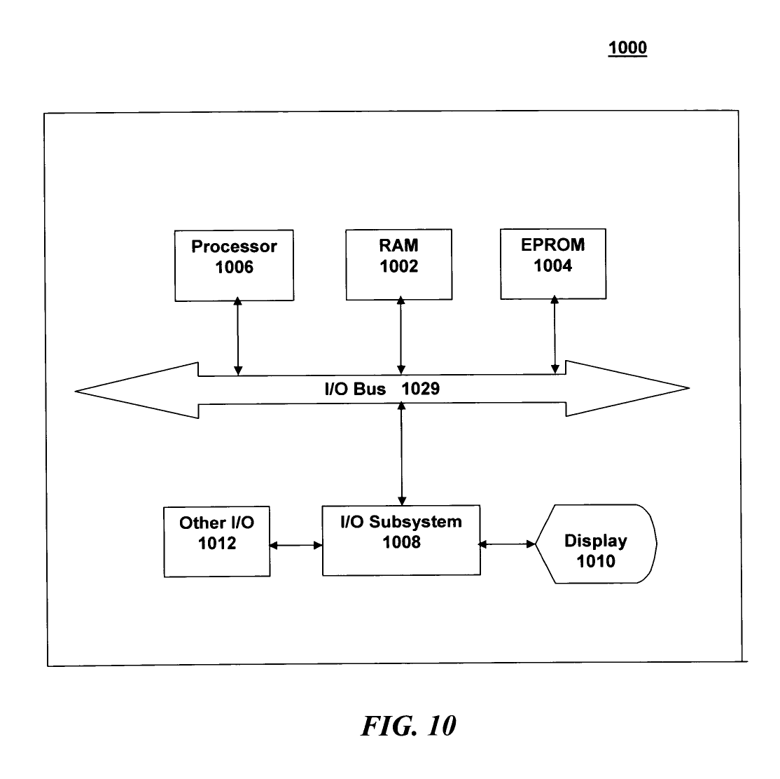

FIG. 10 is a simplified block diagram of a machine 1000 configured to operate according to an embodiment of the invention. According to an embodiment of the invention, the machine 1000, preferably including a time-keeping device, comprises: a high-power Processor 1006 for performing instructions comprising: converting monochrome images to gray scale images; performing spatial dithering algorithms; performing overlap operations. The machine 1000 also includes Random Access Memory 1002, preferably an 8 mb DRAM (Dynamic RAM), and an EPROM (Erasable Programmable ROM) 1004, preferably an 8 mb Flash memory. These are linked by a Bus 1029 to an Input/Output Subsystem 1008, which in turn is linked to a Display 1010 and other Input/Output devices 1012, such as: a port for docking into a computing apparatus, a keyboard, or keypad. What has been shown and discussed is a highly-simplified depiction of a machine 1000. Those skilled in the art will appreciate that other low-level components and connections are required in any practical application of such a machine.

The machine 1000 can be implemented either as an Application Specific Integrated Circuit (ASIC) for generating signals to be presented in the Display 1010 or as program instructions stored in memory, e.g., EPROM 1004 for execution by the Processor 1006.

Therefore, while there has been described what are presently considered to be the preferred embodiments, it will be understood by those skilled in the art that other modifications can be made within the spirit of the invention.

1. A method for transforming multiple one-bit per pixel images for presentation on a device, comprising steps of:
a) converting the one-bit per pixel images to multiple bits per pixel images;
b) overlapping the multiple bits per pixel images, according to an overlap function, to create a composite multiple bits per pixel image;
c) converting the composite multiple bits per pixel image into a dithered one-bit per pixel image by applying a spatial dithering algorithm; and
d) presenting the dithered one-bit per pixel image on a display.

2. The method of claim 1, wherein step a) further comprises applying a first gray level to a first image and a second gray level to a second image wherein the gray levels are applied so as to create visual distinction between the images.

3. The method of claim 1, wherein step b) further comprises employing an overlap function from among the following: AVERAGE, MAX, ADD, and TOP.

4. The method of claim 1 wherein steps a), b), and c) are performed in virtual memory.

5. The method of claim 1, wherein step d) further comprises displaying the dithered one-bit per pixel image on a watch face.

6. The method of claim 1, wherein the device is a hand-held information processing system.

7. The method of claim 1, wherein the device is a one-bit per pixel computer monitor.

8. A method for transforming multiple one-bit per pixel images for presentation on a device, comprising steps of:
a) applying different stipple patterns to each of the one-bit per pixel images to create multiple stippled images;
b) overlaying the stippled images to create a composite stippled one-bit per pixel image; and
c) presenting the composite stippled one-bit per pixel image on a display.

9. The method of claim 8 wherein step a) further comprises selecting stipple patterns so that when multiple stipple patterns overlap black dots from one stipple pattern do not coincide with the black dots from any other stipple pattern.

10. The method of claim 8, wherein the device is a hand-held information processing system.

11. The method of claim 8, wherein the device is a one-bit per pixel computer monitor.

12. The method of claim 8, wherein steps a) and b) are performed in virtual memory.

13. An apparatus for transforming multiple one-bit per pixel images for presentation on a device, comprising logic for performing steps of:
a) converting the one-bit per pixel images to multiple bits per pixel images;
b) overlapping the multiple bits per pixel images according to an overlap function to create a composite multiple bits per pixel image;
c) converting the composite multiple bits per pixel image into a dithered one-bit per pixel image by applying a spatial dithering algorithm; and
d) generating a signal representing the dithered one-bit per pixel image.

14. The apparatus of claim 13 wherein the logic comprises
memory for storing instructions for performing the steps a), b), c) and d); and
a processor for performing the instructions.

15. The apparatus of claim 13, wherein steps a), b), and c) are performed in virtual memory.

16. The apparatus of claim 13 further comprising
a display for presenting the dithered one-bit per pixel image.

17. The apparatus of claim 13, further comprising a timekeeping apparatus wherein the one-bit per pixel image is displayed on a watch face.

18. The apparatus of claim 13, wherein the device is a hand-held information processing system.

19. The apparatus of claim 13, wherein the device is a one-bit per pixel computer monitor.

20. An apparatus for transforming multiple one-bit per pixel images for presentation on a device, comprising logic for performing the steps of:
a) applying different stipple patterns to each of the one-bit per pixel images to create stippled images;
b) overlaying the stippled images to create a composite stippled one-bit per pixel image; and
c) generating a signal representing the composite stippled one-bit per pixel image.

21. The apparatus of claim 20, wherein the device is a hand-held information processing system.

22. The apparatus of claim 20, wherein the device is a one-bit per pixel computer monitor.

23. The apparatus of claim 20 wherein the logic for applying different stipple patterns to each of the one-bit per pixel images further comprises logic for selecting stipple patterns so that when multiple stipple patterns overlap black dots from one stipple pattern do not coincide with the black dots from any other stipple pattern.

24. The apparatus of claim 20, further comprising a timekeeping apparatus wherein the one-bit per pixel image is displayed on a watch face.

25. The apparatus of claim 20, wherein steps a) and b) are performed in virtual memory.
